(19) United States
(12) Patent Application Publication
(10) Pub. No.: US 2019/0263076 A1
(43) Pub. Date: Aug. 29, 2019

(54) Moulding Composite Panels

(71) Applicant: Gurit (UK) Ltd., Hampshire (GB)

(72) Inventor: Daniel Thomas Jones, Isle of Wight (GB)

(21) Appl. No.: 16/312,084

(22) PCT Filed: May 18, 2017
(86) PCT No.: PCT/EP2017/061956

§ 371 Date: Dec. 20, 2018

(30) Foreign Application Priority Data
Jul. 1, 2016 (GB) 1611560.2

(51) Int. Cl. B29C 70/34

(52) U.S. Cl. CPC B29C 70/345

(57) ABSTRACT

A composite panel composed of a fibre reinforced resin matrix composite material, wherein the panel comprises: a panel portion comprised of a first ply of fibre reinforced resin matrix composite material, wherein the first ply includes a first fibrous layer of a plurality of non-woven carbon fibres which are substantially randomly oriented, and a reinforcement portion which is integrally moulded with the panel portion and is located at a location on a surface of the panel portion to provide an integrally moulded primary structural region of the composite panel, the reinforcement portion being comprised of at least one second ply of fibre reinforced resin matrix composite material, the second ply comprising a second fibrous layer, wherein the first ply has a primary portion which is located in the primary structural region and a secondary portion which is adjacent to the primary portion and is located in a secondary structural region of the composite panel, wherein in the primary portion the first ply has a first volume fraction (V_{f1}) of fibres in the first ply which is higher than a second volume fraction (V_{f2}) of fibres in the first ply in the secondary portion, each volume fraction being with respect to the total volume of resin and fibres in the respective portion.

The present invention relates to a composite panel composed of a fibre reinforced resin matrix composite material. The present invention also relates to a method for manufacturing a composite panel composed of a fibre reinforced resin matrix composite material. In particular, the method of the present invention enables the manufacture of various components, in particular for vehicles, such as automobiles, aircraft, or railway locomotives and carriages, for example body panels, such as automotive body panels or body panels for other vehicles, floor pans, pillars, seats, interior panels, structural components, etc. comprising fibre reinforced resin matrix composite materials.

In the field of automotive body panels, a significant weight saving can be achieved by replacing current metallic automotive body panels with composite materials. With lower cost tooling, significant savings can be made in lower volume production runs.

High performance body panel parts are required to have the combination of lightness and strength, in particular stiffness. The panel member may have a low weight but may require reinforcing members bonded thereto at particular locations to reinforce the panel, for example to provide reinforced mounting points and to provide the panel with vehicle or human impact properties required by law or other regulations. The incorporation of reinforcing members onto the panel member can add excessive weight to the body panel, and can be expensive to manufacture.

It is accordingly an aim of this invention to provide a composite panel incorporating a reinforcement which can be manufactured at a lower cost and can have a lower weight than known reinforced composite panels, which can overcome at least some of these significant disadvantages with known panels.

It is known to compression mould carbon fibre vehicle body panels using carbon sheet moulding compound (SMC), prepregs and resin transfer moulding (RTM) processing methods at very high moulding pressures, for example greater than 60 bar, even greater than 80 bar, in order to obtain a high quality moulded surface, in particular that can qualify as A-surface quality body panel that can be painted either directly or with minimal surface preparation, and a defect-free laminate structure. However, such high moulding pressures can only be achieved using correspondingly a high moulding pressure press mould and press, which has a high capital cost, and high operating costs. The pressure distribution within a mould tool can be complex and in this specification the moulding pressure is referred to as the force applied by the press divided by the area of the part projected onto the plane containing the press tool base and press platens.

It is accordingly an aim of this invention to provide a method of manufacturing a carbon fibre composite panel which can be manufactured at lower cost than some known manufacturing processes.

It is known to use carbon fibre layers to form the outer surface of a vehicle body panel. When the carbon fibres in the layer are randomly oriented, there is less fibre pattern which may print through to the outer surface of the vehicle body panel, which can improve the surface smoothness. However, commercially available carbon fibre layers in which the carbon fibres are randomly oriented typically include needle holes which can result in the formation of resin rich areas within the cured resin matrix of the resultant composite material. Such resin rich areas can cause visible defects in the outer surface of a vehicle body panel.

It is accordingly an aim of this invention to provide a carbon fibre composite panel, and a method of manufacturing such a carbon fibre composite panel, which can reduce the visible defects in the outer surface of a vehicle body panel resulting from resin rich areas.

The present invention provides a composite panel composed of a fibre reinforced resin matrix composite material, wherein the panel comprises:

a panel portion comprised of a first ply of fibre reinforced resin matrix composite material, wherein the first ply includes a first fibrous layer of a plurality of non-woven carbon fibres which are substantially randomly oriented, and

a reinforcement portion which is integrally moulded with the panel portion and is located at a location on a surface of the panel portion to provide an integrally moulded primary structural region of the composite panel, the reinforcement portion being comprised of at least one second ply of fibre reinforced resin matrix composite material, the second ply comprising a second fibrous layer,

wherein the first ply has a primary portion which is located in the primary structural region and a secondary portion which is adjacent to the primary portion and is located in a secondary structural region of the composite panel,

wherein in the primary portion the first ply has a first volume fraction (V_{f1}) of fibres in the first ply which is higher than a second volume fraction (V_{f2}) of fibres in the first ply in the secondary portion, each volume fraction being with respect to the total volume of resin and fibres in the respective portion.

In this specification the term “substantially randomly orientated” meant that regular repeating fibre angles are not present, in contrast to the case of a unidirectional, woven, or multiaxial fabric.

In the preferred embodiments of the invention the reinforcement portion comprises carbon fibres, in particular a fibrous layer of a plurality of non-woven carbon fibres which are substantially randomly oriented, in alternative embodiments of the invention the reinforcement portion may be composed of any other type of fibres or fibrous layer, for example glass fibres, or any mixture of fibres, for example glass and carbon fibres, and/or the reinforcement portion may be composed of any other type of fibrous layer, for example a woven fabric.

The present invention further provides a method of manufacturing a composite panel composed of a fibre reinforced resin matrix composite material, the method comprising the steps of:
i. locating in a moulding cavity of a mould tool of a press mould an assembly of a panel part and a reinforcement part which is disposed adjacent to the panel part and is located at one or more locations on a surface of the panel part to provide one or more primary structural areas of the assembly, there being at least one secondary structural area of the panel part adjacent to the primary structural area, the panel part being comprised of a first ply which includes a first fibrous layer of a plurality of non-woven carbon fibres which are substantially randomly oriented, and the reinforcement part being comprised of at least one second ply which includes a second fibrous layer, and the panel part and reinforcement part being provided with a resin; and
ii. press moulding the assembly in the mould tool to cause the resin to impregnate fibrous layers of the assembly and form a composite panel composed of a fibre reinforced resin matrix composite material in which a reinforcement portion, formed from the reinforcement part, is integrally moulded with the panel portion, formed from the panel part, to provide one or more primary structural regions of the composite panel, wherein the mould tool applies a higher compressive pressure to the one or more primary structural areas of the assembly than to the at least one secondary structural area of the panel part, the at least one secondary structural area of the panel part forming at least one secondary structural region of the composite panel.

In preferred embodiments of the present invention, a front surface of the composite panel may be provided by a front surface of the panel portion, with the reinforcement portion being located on an opposite rear surface of the panel portion. The reinforcement portion provides structural stiffness and strength to the panel portion. The front surface typically provides a high quality surface finish, and may optionally be covered by a surfacing film. Preferably, the front surface of the composite panel may be ready for painting to an A-surface finish. In this specification, the term “A-surface” means the final intended visible cosmetic surface, for example the exterior surface of an automotive hood, or in the case of an separately moulded inner stiffener bonded to that hood the surface seen when the hood is opened to inspect the engine compartment. The opposite side is the B-surface, which is the surface usually hidden from view or the surface viewed as not having the same cosmetic finish standard if both surfaces are to be seen.

Carbon fibres have a higher density than resin used in fibre reinforced resin matrix composite materials. The greater the fibre volume fraction the greater the composite density. In the secondary structural regions, which are less critical load areas, weight savings can be made by using a second lower volume fraction of fibres (V_{f2}) to form a low density composite which is beneficial when the part thickness is driven by a minimum thickness requirement. Minimum wall thickness can due to the achievable tooling cavity tolerance; or may be set for a design purpose such as preventing phenomena such as panel crimping and shear web buckling. In the primary structural areas requiring greater strength and stiffness, the provision of a first higher volume fraction (V_{f1}) gives a composite material with high specific properties which is advantageous for strength and higher stiffness but has a greater density. A difference in fibre volume fraction between the primary and secondary structural regions of the composite panel can provide the combination of sufficient reinforcement without excessive addition of weight, while being able to provide an integral moulding of the panel and reinforcement portions employing fibrous layers of a plurality of non-woven carbon fibres which are substantially randomly oriented.

Such fibrous layers of a plurality of non-woven carbon fibres which are substantially randomly oriented can have “loft”; in other words the fibrous layer significantly compresses under load and significant pressures are required to compact the material to a high volume fraction. During manufacture of the composite panel by press moulding, different moulding pressures are applied to the primary and secondary structural regions to compress the fibrous layers by a greater compression ratio in the primary structural region(s) as compared to the secondary structural region. This results in the difference in fibre volume fraction, and consequently the difference in density, between the primary and secondary structural regions of the composite panel. In addition, the higher fibre volume fraction in the primary structural region can provide enhanced structural reinforcement while maintaining a low total panel weight.

This provision of differential fibre volume fractions in the composite panel can provide the combination of sufficient reinforcement without excessive addition of weight, while being able to provide an integral moulding of the panel and reinforcement portions employing fibrous layers of a plurality of non-woven carbon fibres which are substantially randomly oriented. The density of the secondary structural region is lower than density of the primary structural region(s). Accordingly, lighter and lower cost reinforced carbon fibre laminates can be manufactured.

In currently known carbon fibre articles such as automotive parts, the carbon fibre composite material can have localised regions of high fibre content. In the present invention, by only compacting the fibre in primary structural regions to achieve a high volume fraction, problems caused from areal weight variation in the non-woven material can be mitigated.

In particular, in the present invention the primary structural regions of the laminate are generally thick and formed from multiple fabric layers, and consequently a high spot of one fabric, caused by a local higher amount of fibre from the fabric manufacturing process, located against another high spot of an adjacent fabric is more easily accommodated in the bulk of the laminate.

In contrast, in the secondary structural regions of the laminate, which generally are thinner than the primary structural regions and typically composed of from 1 to 3 fabric layers, any attempt to compact the non-woven fabric to achieve a high volume fraction may cause a problem in closing the press moulding tool. If a localised area of high total fabric weight (grams per square metre, or gsm) is compressed together with another localised fibre area which at least partially overlaps the localised area, a large pressing force is required to compact the multilayer fibre assembly. The fibre tends not to re-distribute itself during impregnation. If attempting to mould at a high volume fraction, the press moulding tool can fail to close, leaving visible surface witness marks and other defects in the resultant composite material.

In addition, the reduced compression forces in the secondary structural region, which comprises the thin panel portion, more readily accommodates the presence of resin rich areas in the panel portion without exhibiting visual defects in the panel surface. With a lower number of plies and a low fibre volume fraction in the thinner secondary structural region, any localised low areal weight of fibre in a fibre ply would be less likely to form a volume fraction contrast or resin differential zones between neighbouring fibrous material portions. Accordingly, the low fibre volume fraction can result in a visual appearance of the panel surface which js less likely to appear patchy or non-uniform. The primary structural region is relatively thick and so the increased thickness can accommodate the presence of localised variations in fibre areal weight or resin rich areas in one or more plies without exhibiting visual defects or introducing structural defects in the primary structural region.

In the present invention, the non-woven carbon fibre material can be differently pressed to achieve different volume fractions exhibiting different properties, in particular so that a high volume fraction region has high specific structural properties. The high specific structural properties are useful to create a locally reinforced article from the one fibrous starting material, i.e. the non-woven carbon fibre material.

In contrast, differential moulding pressures applied to woven fibrous materials would tend to form undesirable resin rich areas in the composite material.

The use in the present invention of a non-woven carbon fibre material to form both a panel portion with a lower fibre volume fraction and a reinforcement portion with a higher fibre volume fraction is in contrast to the currently known method of adding reinforcements composed of additional second material in the form of continuous fibre reinforcements, such as uni-directional prepregs and woven prepregs designed already as a structural material containing less resin to give a high volume fraction of fibre, to a panel portion of non-woven carbon fibre material. If such additional reinforcing layers are added as in the prior art, care is needed to maintain a balanced symmetrical laminate by either: placing additional reinforcing layers in the middle of the laminate stack; or providing the additional reinforcing layers as separate layers either side of the laminate mid-plane to prevent local distortions and residual stresses. This can complicate the manufacture of the known composite preform and moulding.

Furthermore, the present invention can employ lower moulding pressures applied to the composite panel, which, as compared to high pressure moulding processes, can more readily accommodate tooling tolerance.

The present invention enables the manufacture of various components, in particular for vehicles, such as automobiles, aircraft, or railway locomotives and carriages, for example body panels, such as automotive body panels or body panels for other vehicles, floor pans, pillars, seats, interior panels, structural components, etc. comprising fibre reinforced resin matrix composite materials.

The present invention further provides a vehicle, component, in particular a body panel, comprising the composite panel of the present invention. In preferred embodiments of the present invention, the vehicle body panel has excellent surface finish, stiffness and strength to weight ratios, and may be ready for painting to an A-surface finish.

Preferred features of the present invention are defined in the respective dependent claims.

Embodiments of the present invention will now be described by way of example, with reference to the accompanying drawings, in which:

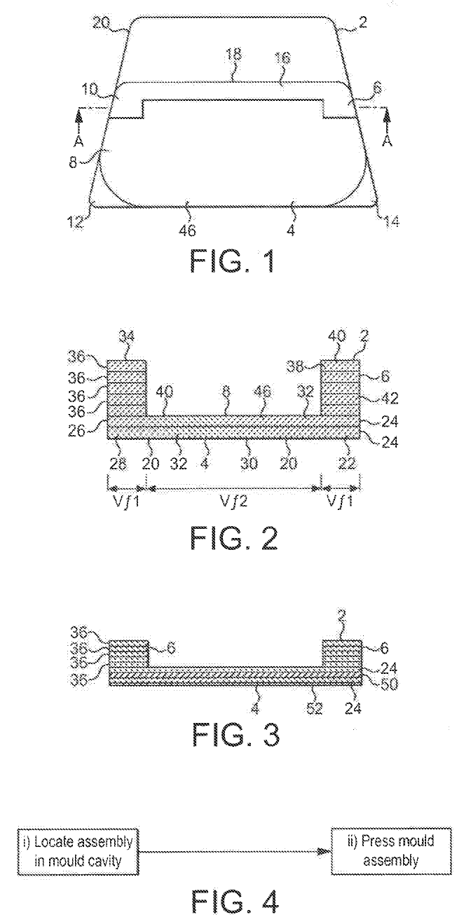

FIG. 1 schematically illustrates a plan view of a rear surface of a vehicle body panel according to an embodiment of the present invention;

FIG. 2 schematically illustrates an enlarged cross-section on line A-A through a part of the vehicle body panel of FIG. 1;

FIG. 3 schematically illustrates an enlarged cross-section through a part of a vehicle body panel according to a second embodiment of the present invention;

FIG. 4 schematically illustrates a process flow of a method for manufacturing the vehicle body panel of FIG. 1;

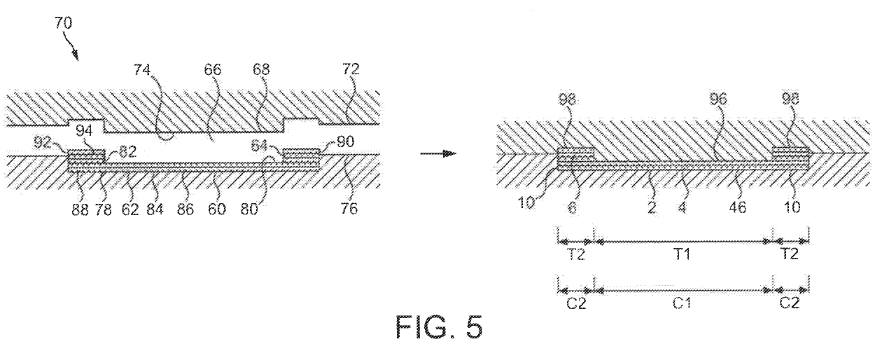

FIG. 5 is a graph schematically illustrating the behaviour of a fibrous layer of a plurality of non-woven carbon fibres which are substantially randomly oriented, the layer having loft, when compressed as compared to a fabric layer;

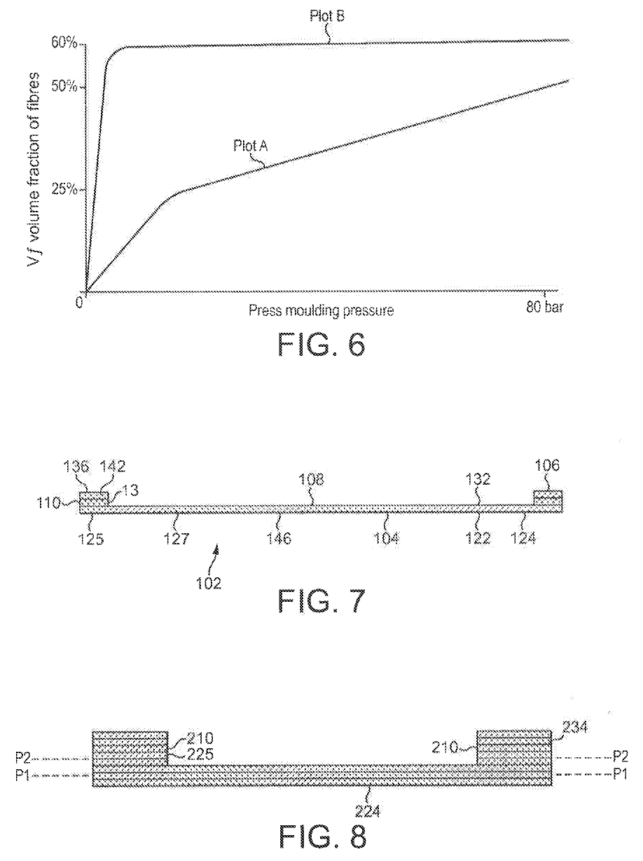

FIG. 6 schematically illustrates the transformation of the preform to the vehicle body panel in the method for manufacturing the vehicle body panel of FIG. 1;

FIG. 7 schematically illustrates an enlarged cross-section through a part of a vehicle body panel according to a third embodiment of the present invention; and

FIG. 8 schematically illustrates an enlarged cross-section through a part of a vehicle body panel according to a fourth embodiment of the present invention.

Referring to FIGS. 1 and 2, there is shown in schematic form a composite panel 2 composed of a fibre reinforced resin matrix composite material. In this embodiment, the composite panel 2 is a vehicle body panel, for example an automobile hood 20. FIG. 1 is a plan view and FIG. 2 is a cross-sectional view on line A-A with the thicknesses greatly exaggerated for clarity of illustration. The composite panel 2 comprises a panel portion 4 and a reinforcement portion 6 which is integrally moulded with the panel portion 4. The reinforcement portion 6 is located at one or more locations on a rear surface 8 of the panel portion 4 to provide one or more primary structural regions 10 of the composite panel 2.

In this embodiment, the primary structural regions 10 provide opposed mounting regions 12, 14 for mounting the automobile hood 20 to a vehicle chassis (not shown) and a central reinforcement 16 extending across the hood 20 for reinforcing a central area 18 of the hood 20 against pedestrian impact and to provide lateral stiffness to the hood 20. This is a simplified structure for clarity of illustration; in commercial vehicle hood and other body panel components there is a very large number of reinforcements of complex shape and dimensions.

The panel portion 4 is comprised of a first multilayer laminate 22 including a plurality of first plies 24 of fibre reinforced resin matrix composite material. Each first ply 24 comprises a fibrous layer 26, typically of carbon fibres, in a resin matrix 28, typically a thermoset resin. The thermoset resin, may comprise an epoxy, vinyl ester, polyester, acrylic, cyanate ester, phenolic, furan, or benzoxazine resin. Typically, the thermoset resin comprises an epoxy resin. The first multilayer laminate 22 defines at least a part of a front surface 30 of the composite panel 2. The first multilayer laminate 22 extends over from 50 to 100%, typically from 90 to 100%, for example 100%, of the front surface 30 of the panel 2.

At least one of the first plies 24 includes a first fibrous layer 32 of a plurality of non-woven carbon fibres which are substantially randomly oriented, hereinafter called a random fibrous layer 32. In preferred embodiments, the first multilayer laminate 22 comprises at least two first plies 24, each of which includes a random fibrous layer 32. In the illustrated embodiment, the first multilayer laminate 22 consists of a plurality of the first plies 24, each of which includes a random fibrous layer 32.

The reinforcement portion 6 is comprised of a second multilayer laminate 34 including a plurality of second plies 36 of fibre reinforced resin matrix composite material. Each second ply 36 comprises a fibrous layer 38, typically of carbon fibres, in a resin matrix 40, typically a thermoset resin such as an epoxy resin. The second multilayer laminate 34 is located at one or more locations on the rear surface 40 of the panel 2 and integrally moulded to the rear surface 8 of the first multilayer laminate 22. The second multilayer laminate 34 extends over less than 50% of the rear surface 40 of the composite panel 2.

At least one of the second plies 36 includes a second fibrous layer 42 of a plurality of non-woven carbon fibres which are substantially randomly oriented, again hereinafter called a random fibrous layer 42. In preferred embodiments, the second multilayer laminate 34 comprises at least four second plies 36, each of which includes a random fibrous layer 42. In the illustrated embodiment, the second multilayer laminate 34 consists of a plurality of the second plies 36, each of which includes a random fibrous layer 42.

In at least one primary structural region 10 both the panel portion 4 and the reinforcement portion 6 have a first volume fraction (V_{f1}) of fibres in the respective first and second plies 24, 36 within the respective primary structural region 10 which is higher than a second volume fraction (V_{f2}) of fibres in at least one of the first plies 24 of the panel portion 4 in a secondary structural region 46 of the composite panel 2. Each volume fraction is defined with respect to the total volume of resin and fibres.

In some embodiments, the first volume fraction (V_{f1}) is from greater than 30 vol % to up to 55 vol % and/or the second volume fraction (V_{f2}) is from 15 vol % to 30 vol %. Preferably, the first volume fraction (V_{f1}) is from greater than 30 vol % to 45 vol %, typically from 35 vol % to 45 vol %, and/or the second volume fraction (V_{f2}) is from 15 vol % to 30 vol %, typically from 15 vol % to 25 vol %.

In one example, the first volume fraction (V_{f1}) is 45+/−5 vol % and the second volume fraction (V_{f2}) is 25+/−5 vol %.

The first and second random fibrous layers 32, 42 in the at least one primary structural region 10 have a thickness which is less than the thickness of the or each first random fibrous layer 32, 42 in the secondary structural region 46. The first and second random fibrous layers 32, 42 in the at least one primary structural region 10 have a fibre volume fraction V_{f1} which is higher than the fibre volume fraction V_{f2} of the or each first random fibrous layer 32, 42 in the secondary structural region 46.

In some embodiments, the at least one primary structural region 10 has a thickness of from 1.0 to 7.0 mm, optionally from 1.5 to 6.0 mm and/or the secondary structural region 46 has a thickness of from 0.5 to 1.5 mm, optionally from 0.7 to 1.2 mm.

Typically, a common first random fibrous layer is present in each of the first plies 24 and/or a common second fibrous layer is present in each of the second plies 36. In some embodiments, the first and second fibrous layers 32, 42 comprise a common fibrous layer which is present in each of the first and second plies 24, 36. In this specification a “common” fibrous layer means that the same fibrous material has been made to make the respective layers, although the layers may be compressed to a different thickness and may have a different fibre volume fraction V_{f}.

Each random fibrous layer 32, 42 comprises a plurality of non-woven carbon fibres, which are substantially randomly orientated. The random fibrous layer 32, 42 has interstices between the carbon fibres which have absorbed thermosetting resin during a resin infusion step. The non-woven carbon fibres may be chopped and/or cut fibres. Thus, the random fibrous layer 32, 42 may comprise chopped and/or cut fibres. Such chopped and/or cut carbon fibres may have a length of less than 250 mm Optionally, at least 50 wt % of the fibres have a length of from 10 to 150 mm, optionally from 10 to 50 mm and further optionally from 10 to 30 mm.

The random fibrous layer 32, 42 may have a fibre weight of greater than 100 grams per square metre, optionally from 100 to 600 grams per square metre and further optionally from 150 to 250 grams per square metre.

In the illustrated embodiment, each of the plies 24, 36 of fibre reinforced resin matrix composite material in the panel includes a first or second random fibrous layer 32, 42.

However, in alternative embodiments, at least one or both of the first and second multilayer laminates 22, 34 further comprises at least one additional layer.

FIG. 3 schematically illustrates an enlarged cross-section through a part of a vehicle body panel 2 according to a further embodiment of the present invention. An additional layer 50 is centrally located at the neutral axis of the panel portion 4. The additional layer 50 may be a fabric ply, for example a multiaxial, woven, or non-woven fabric. The additional layer 50 may comprise a syntactic layer which typically comprises a resin and hollow microspheres, and optional flow control agents, dispersed therein. The additional layer 50 may be a unidirectional fibre layer. The fabric ply and/or unidirectional fibre layer typically comprises carbon fibres. The additional layer may comprises more than one unidirectional fibre layer, and the fibres in each of the more than one unidirectional prepregs may be aligned in a direction so as to provide greater stiffness and strength to the laminate. Optionally, the direction of the fibres in each of the more than one unidirectional fibre layers are staggered with respect to each other. To avoid unwanted tension shear-coupling, a multi-axial, cross ply or quasi-isotropic laminate could be formed using plies of unidirectional fibres, each comprising unidirectional fibres which are aligned at different fibre angles relative to each other. Any combination of these additional layers may be employed. When such an additional layer 50 is provided, preferably the layer structure is symmetric about a central neutral axis of the panel portion so as to reduce any warping of the panel portion as a result of different thermal expansion of the layers. The additional layer 50 may comprise a resin, which may optionally comprise a particulate filler material, the particulate filler material to impart further strength, toughness, and/or stiffness such as milled or chopped carbon fibre, wollastonite, impact modifiers, rubbers and thermoplastic particles. In a preferred embodiment the particulate filler comprises milled or chopped carbon fibre.

As shown in FIG. 3, the composite panel 2 may further comprises at least one surface film 52 which comprises a thermoset resin and particulate filler material dispersed therein. The composite panel typically has one surface film 52 forming an A-surface. Alternatively, two surface films may be provided, on respective opposite faces of the composite panel, to provide opposed A-surface. The thermoset resin in the surface film 52 is preferably the same resin as used in the plies 24, 36 of fibre reinforced resin matrix composite material in the composite panel 2. The surface film 52 may have a thickness of from 100 to 600 microns, for example from 200 to 500 microns. Typically, the surface film 52 has a weight of from 200 to 900 grams per square metre. Optionally, the weight of the surface film 52 is from 300 to 700 grams per square metre, further optionally 400 to 600 grams per square metre. The surface film 52 typically has a filler material concentration of from 2 to 40 vol %, based on the volume of the surface film 52. Optionally, surface film 52 has a filler material concentration of from 2 to 20 vol %, based on the volume of the surface film 52.

The filler material in the surface film 52 typically comprises an inorganic material. For example, the filler material may comprise talc, calcium carbonate, silica, alumino-silicate ash, chalk, clay minerals, marble dust, slate powder or silicon carbide. Optionally, the filler may comprise or consist of talc, for example Magil Star 350# talc. The filler material may have a weight of from 80 to 400 grams per square metre, and/or an average particle size of from 5 to 30 microns. Optionally, the average particle size of the filler material is from 8 to 20 microns, for example about 12 microns. Typically, at least 98 wt % of the particulate filler material passes through a 45 micron sieve. Optionally, the filler material has a particle size distribution of 99 wt % less than 75 microns, 84 wt % less than 30 microns, 68 wt % less than 20 microns and 48 wt % less than 10 microns.

In alternative embodiments, the filler may comprise milled carbon fibre having a length of from 20 to 150 microns, preferably from 20 to 100 microns.

Referring to FIG. 7, there is shown in schematic form a composite panel 102 composed of a fibre reinforced resin matrix composite material in accordance with another embodiment of the present invention. In this embodiment, the composite panel 102 is a vehicle body panel, for example an automobile hood 20 as shown in FIG. 1. FIG. 7 is a cross-sectional view with the thicknesses greatly exaggerated for clarity of illustration. The composite panel 102 comprises a panel portion 104 and a reinforcement portion 106 which is integrally moulded with the panel portion 104. The reinforcement portion 106 is located at one or more locations on a rear surface 108 of the panel portion 104 to provide one or more primary structural regions 110 of the composite panel 102.

In this embodiment, as compared to the embodiment of FIG. 1, the panel portion 104 is comprised of a first laminate 122 including a single first ply 124 of fibre reinforced resin matrix composite material. The first ply 124 comprises a fibrous layer of a plurality of non-woven carbon fibres which are substantially randomly oriented, in a resin matrix, typically a thermoset resin, as described for the embodiment of FIG. 1. Typically, the thermoset resin comprises an epoxy resin. The first ply 24 is a random fibrous layer 132. In alternative embodiments, the first laminate 122 comprises at least two first plies 124, each of which includes a random fibrous layer 132. In the illustrated embodiment, the first laminate 122 consists of only one first ply 124, which includes a random fibrous layer 132.

The reinforcement portion 106 is comprised of a second multilayer laminate 134 including a plurality of second plies 136 of fibre reinforced resin matrix composite material. As for the embodiment of FIG. 1, each second ply 136 comprises a fibrous layer 142, typically of a plurality of non-woven carbon fibres which are substantially randomly oriented, in a resin matrix, typically a thermoset resin such as an epoxy resin. The second multilayer laminate 134 is located at at least one location, or optionally plural locations, on the rear surface of the panel 102 and integrally moulded to the rear surface of the first laminate 122.

The first ply 124 has a primary portion 125 which extends into the primary structural region 110 and a secondary portion 127 which is adjacent to the primary portion 125 and is located in a secondary structural region 146 of the composite panel 102.

In the primary portion 125 the first ply 124 has a first volume fraction (V_{f1}) of fibres in the first ply 124 which is higher than a second volume fraction (V_{f2}) of fibres in the first ply 124 in the secondary portion 127, each volume fraction being with respect to the total volume of resin and fibres in the respective portion.

In some embodiments, the first volume fraction (V_{f1}) is from greater than 30 vol % to up to 55 vol % and/or the second volume fraction (V_{f2}) is from 15 vol % to 30 vol %. Preferably, the first volume fraction (V_{f1}) is from greater than 30 vol % to 45 vol %, typically from 35 vol % to 45 vol %, and/or the second volume fraction (V_{f2}) is from 15 vol % to 30 vol %, typically from 15 vol % to 25 vol %.

In one example, the first volume fraction (V_{f1}) is from 35 to 45 vol % and the second volume fraction (V_{f2}) is from 20 to 35 vol %, with the proviso that the first volume fraction (V_{f1}) is higher than the second volume fraction (V_{f2}).

In another example, the first volume fraction (V_{f1}) is 45+/−5 vol % and the second volume fraction (V_{f2}) is 25+/−5 vol %.

Furthermore, in this embodiment, the primary structural region 110 of the composite panel 102 has a greater first thickness (T1) and a higher first volume fraction (V_{f1}) of fibres than a second thickness (T2) and a second volume fraction (V_{f2}) of fibres in the second structural region 146, each volume fraction being with respect to the total volume of resin and fibres in the respective region.

In other aspects, such as the fibrous layer thickness in the primary structural region 110 and the secondary structural region 146, the composition of the random fibrous layers 132, 142 and the provision of an additional layer, and including the method of manufacturing the composite panel, the composite panel of this embodiment is similar or the same as for the embodiments of FIG. 1 or 3.

Referring to FIG. 8, which schematically illustrates an enlarged cross-section through a part of a vehicle body panel according to a fourth embodiment of the present invention, in any embodiment of the present invention, in particular the embodiments of FIG. 1 or 3, the first multilayer laminate 224 has a first layer symmetry about a central plane P1 in the first multilayer laminate 224 and in the integrally moulded primary structural region 210 an integral moulding 225 of the first multilayer laminate 224 and the second multilayer laminate 234 has a second layer symmetry about a central plane P2 in the integral moulding 225.

Each central plane P1 and P2 is located at a substantially central dimensional location, typically within +/−25% of the dimensional centre, for example within +/−10% of the dimensional centre, with respect to the thickness of the respective laminate 224 or integral moulding 225. The central planes can pass through a ply or pass along an interface of adjacent plies. The symmetry is provided by a reflective symmetrical relationship on opposite sides of the respective plane for at least one, optionally more than one, of the mechanical properties of the composite panel, for example number of plies, fibre properties (such as fibre weight per unit area), tensile strength, and thermal expansion coefficient. The symmetry provides that the respective neutral axes, with respect to the mechanical properties, of both the reinforced part of the composite moulding and the unreinforced part of the composite moulding, are substantially located at the respective dimensional centre of the respective part of the composite moulding. The practical technical effect is that both the reinforced part of the composite moulding and the unreinforced part of the composite moulding have a high resistance against warping as a result of temperature or mechanical load variations because the neutral axis for each part is centrally located. This provides a highly thermally and mechanically stable panel structure using, in the preferred embodiment, only a single fibrous material, in particular composed of non-woven carbon fibres which are substantially randomly oriented, to provide the structural layers of the both the reinforced and unreinforced parts of the composite moulding, and most particularly both the front surface, which may have an A-surface finish, and an opposite B-surface.

Referring to FIGS. 4 and 5, there is shown a method of manufacturing the composite panel of FIG. 1 which is composed of a fibre reinforced resin matrix composite material.

In the method, in a first step i, an assembly 60 of a panel part 62 and a reinforcement part 64 is located in a moulding cavity 66 of mould tool 68 of a press mould 70. The mould tool 68 has an upper mould element 72 defining an upper moulding surface 74 and a lower mould element 76 defining a lower moulding surface 78. For a vehicle body panel 2, typically the lower moulding surface 78 moulds and defines the A-surface of the resultant composite panel 2, although the alternative arrangement could be employed.

In the assembly 60, the reinforcement part 64 is disposed adjacent to the panel part 62. The reinforcement part 64 is located at one or more locations on a surface 80 of the panel part 62 to provide one or more reinforced areas 82 of the assembly 60.

The panel part 62 is comprised of a first multilayer laminate 84 including a plurality of first plies 86. At least one of the first plies 86 includes a first fibrous layer 88 of a plurality of non-woven carbon fibres which are substantially randomly oriented. The reinforcement part 64 is comprised of a second multilayer laminate 90 including a plurality of second plies 92. At least one of the second plies 92 includes a second fibrous layer 94 of a plurality of non-woven carbon fibres which are substantially randomly oriented.

The panel part 62 and the reinforcement part 64 are provided with a resin. As described above, an additional layer and/or a surface resin film may also optionally be provided.

In one embodiment the panel part 62 and the reinforcement part 64 comprise prepregs, incorporating a resin layer adjacent to or at least partly impregnating the first plies 86 and second plies 92. Depending on the part complexity, the prepreg layers may be first drape formed, typically using a matched tool set in a double diaphragm vacuum forming process. The prepreg layup is then subjected to compression moulding to form the moulded product, as described below.

Alternatively, in another embodiment, the panel part 62 and the reinforcement part 64 comprise a preform coated with, or containing, one or several coatings of liquid resin between the fibrous layers. The preform has typically been made by stacking dry fibrous layers to form a laminate and then the laminate has been coated with a wet liquid resin. The liquid resin typically has a viscosity of from 5 to 1200 cP (centipoise), optionally 5 to 900 cP, at the resin coating temperature used. Thereafter the resin can optionally be B-staged (i.e. partly cured) to increase the rigidity of the preform prior to transfer to a mould tool for compression moulding to form the moulded product, as described below. Preferably, the B-staging step is carried out during the drape forming process and the preform removed from the drape forming apparatus once the B-staging is completed to give a more rigid low tack or dry impregnated or partially impregnated preform for easier handling and transfer to an optional cutting operation, further laminating operation, or simply placed in a holder ready to be loaded into the final mould tool. Alternatively, the laminate coated with a wet liquid resin can be transferred directly to a mould tool for compression moulding to form the moulded product, as described below.

In a further alternative embodiment, the panel part 62 and the reinforcement part 64 are formed by a gap impregnation resin transfer moulding (RTM) process. The assembly may comprise a layup of dry fibre layers. The assembly is located in the mould cavity of the mould tool and the mould tool is not fully closed to provide a gap above the assembly in the mould cavity. Then liquid resin is injected into the mould cavity, via an injection line from a remote supply of resin, so as to commence impregnation of the fibre layers in a resin transfer moulding (RTM) process. The liquid resin typically has a viscosity of from 5 to 1200 cP (centipoise), optionally from 5 to 900 cP, at the injection temperature used. The assembly is not fully compressed during the injection so that the resin has a high degree of infusion into the fibrous layers, which have a high permeability as a result of the loft of the uncompressed fibrous layers. The injection is then terminated after a desired measured dose of resin has been injected into the mould cavity, and a valve on the injection line is closed. The press mould is then fully closed to complete the impregnation and compaction of the fibrous layers to the desired volume fraction in each region.

In the preferred embodiment, the assembly may comprise a prepreg layup, optionally preshaped as a preform, in which fibre layers and resin have been combined and the resin at least partially impregnates the fibre layers. Optionally, the preform is consolidated and the thermosetting resin has been B-staged so that the preform comprises a more rigid prepreg. Although initial prepreg material from a preformed roll may be employed to form the prepreg layup, alternatively the rigid prepreg may preferably be formed by a wet resin process and subsequent B-staging which is a low cost manufacturing process. The B-staging of the liquid resin effectively turns the liquid coated preform into a partially or fully impregnated prepreg preform depending on the pressure applied. The preform has an advantage of greater rigidity than dry fibre layers. The assembly may be assembled off line, optionally in a preform mould, and then located in the mould, or the assembly may be assembled in the mould. The assembly is typically loaded into the mould cavity such that the surface to form the A-surface, and in particular a surface film when present, is located toward a moulding surface of the mould, typically the lower mould part.

In a subsequent press moulding step ii, the assembly 60 in the mould tool 68 is press moulded to cause the resin to impregnate fibrous layers of the assembly 60 and form a composite panel 2 composed of a fibre reinforced resin matrix composite material. As shown in FIGS. 1 and 2, in the composite panel 2, a reinforcement portion 6, formed from the reinforcement part 64 is integrally moulded with the panel portion 4, formed from the panel part 62, to provide one or more primary structural regions 10 of the composite panel 2.

The moulding step may be conducted at a net equivalent pressure of from 10 to 80 bar, typically from 20-50 bar, this being the pressure applied to the mould tool by the moulding press. The moulding step may optionally be conducted at a temperature of from 80-250° C., typically at a temperature of from 120-220° C.

When a preform is loaded into the mould, the loft of the non-woven fibrous layer is such that a significant volume fraction of void space remains in the unimpregnated fibrous layer during the loading and pre-closing step of the mould. The void passages are maintained even when the thermosetting resin begins to warm and soften. The void passages provide an air escape route that allows any entrapped air within the preform, and the resin as the resin heats up and lowers in viscosity, to escape from the preform during a vacuum hold stage, which occurs before the moulding step. Materials having less loft and which are easily impregnated do not provide such efficient degassing of air channels within the ply stack.

The preform may be formed by subjecting an assembly of fibrous layers and resin, optionally in the form of prepreg layers, to a temperature of from 0 to 150° C. and/or a preform moulding pressure of from 0.01 to 80 bar or more preferably 0.9 to 50 bar to form the preform in a preform mould.

The preform may be subsequently cooled prior to insertion into the mould cavity to make the preform more rigid.

The preform may be partially or fully impregnated prior to loading into the mould tool. An advantage of providing a preform prior to the moulding step described hereinbelow instead of laying a prepreg directly into the mould is that the preform can be shaped, and optionally trimmed, to the correct size and form is more rigid, can be easily handled into the tool. The draping steps to form the preform can be done at a more controlled rate and viscosity of the resin rather than at the final cure temperature where the resin would quickly gel and cure. Thus, the correct resin and fibre ratio and shape can be prepared off-line from the main tool and faster overall cycle times achieved.

During the moulding step, a vacuum is applied to the cavity of the mould and then a closure load is applied to the mould to generate a pressure in the cavity of the mould. This causes at least a portion of the thermosetting resin to infuse, i.e. migrate, into the fibrous layer to fully or partially impregnate the carbon fibres. Typically, the carbon fibres are fully impregnated by the thermosetting resin.

The press mould 70 applies a closure force to the mould tool, the closure force optionally being less than 10,000 kiloNewtons, further optionally less than 5,000 kiloNewtons. The press mould 70 therefore applies a closure pressure across a moulding area of the mould tool 68. Typically, the press mould 70 applies a pressure within the range of from 2 to 50 bar, optionally from 2 to 30 bar, across a moulding area of the mould tool 68.

A net pressure is applied to the mould tool 68. The net pressure is the force applied to the mould tool 68 by the press mould 70 divided by the moulding area of the assembly being press moulded, the moulding area being projected onto a central plane of the mould tool 68 which is orthogonal to the press moulding direction. Typically, the net pressure is within the range of from 2 to 50 bar, optionally from 2 to 30 bar, across the moulding area.

This can generate localised compressive pressures of from 10 to 80 bar, optionally from 20 to 50 bar, within the moulding area. By applying the closure load to the mould tool 68, different regions of the assembly 60 are compressed under different compression pressures as a result of differences between the initial thickness of a region to be compressed, which is the initial thickness of the respective region of the assembly 60, and a final thickness of the resultant moulding, which is the gap of the moulding cavity 66 at the location to mould that region of the assembly 60.

The panel part 62 and the reinforcement part 64 each include at least one ply which comprises a fibrous layer of a plurality of non-woven carbon fibres which are substantially randomly oriented. Such a layer is selected to have loft, which provides that the layer is compressible.

The random fibrous layer typically has a loft such that the fibrous layer is compressed in thickness by at least 30%, typically at least 45%, more typically at least 50% of the uncompressed thickness when subjected to a compressive load of 1 bar at 18-23° C.

The fibrous layer comprises a plurality of non-woven carbon fibres, which are substantially randomly orientated. The fibrous layer has interstices between the carbon fibres dimensioned for absorbing at least a portion of the thermosetting resin during a resin infusion step.

The fibrous layer has interstices between the carbon fibres which are dimensioned for absorbing thermosetting resin during a resin infusion step.

The carbon fibres may be recycled carbon fibres (recycled fibre sources), for example from commercial carbon fibre and carbon fibre fabric suppliers such as ELG Carbon Fibre Ltd, SGL Group, Saertex and Formax. The advantage of recycled carbon fibres is that the cost and carbon footprint of the method used to manufacture the fibrous layer is reduced. The fibrous layer may be formed as a batt, optionally where the batt is formed of single or multiple fibre layers.

The fibrous layer may be manufactured by a carding process. Following the carding process, a multiply-layered substantially randomly oriented fibre matt may be formed by a needling process to entangle the fibrous layers and enable it to be subsequently wound and handled in a roll format. Thus, the fibrous layer may comprise sub-layers, the sub-layers being optionally interconnected by needling. Stitching of the matt induces print marks into the final surface and a greater surface resin layer is needed to mask the stitching marks and is not preferred. The fibrous layer may therefore optionally comprise needle holes, which are formed during the needling.

Alternatively the fibrous layer may be formed by first dispersing the fibres in an aqueous binder solution, forming and drying a web of multiply-layered substantially randomly oriented fibres and optionally compressing to assist the binder locally adhering the fibres to form a stable matt of fibrous layers each comprising substantially randomly oriented fibres, in particular carbon fibres.

The thickness of the initial fibrous layer, when not subjected to any compressive load, and prior to incorporation into any preform, may be from 500 microns to 10 mm, preferably from 2 to 10 mm, typically from 3 to 8 mm.

Three examples of fibrous layers comprising a plurality of non-woven carbon fibres which are substantially randomly orientated are set out below in Table 1. Table 1 lists a description of each material, together with its thickness (in mm) when not under a compressive load, the thickness (in mm) when under a compressive load of 1 bar at 23° C., a ratio (%) between the compressed thickness and the uncompressed thickness, and a compaction ratio (%) between the uncompressed thickness and the compressed thickness.

In Table 1, the compaction of the fibrous layer was measured using a Zwick Mechanical Testing machine. Three plies of 100×100 mm dry fibrous material were compressed between two 80 mm cylinders. The vertical displacement was first zeroed by closing the cylinders with no material present. The cylinders were then opened and the material placed between. The cylinders were then closed and the point of first contact noted. Further force was applied to measure the thickness of the material stack vs. the applied pressure. The average ply thickness from 5 different test specimens was used.

TABLE 1

| | | Initial | Thickness | % | |
|---|---|---|---|---|---|
| | | Thickness | @ 1 bar | of starting | % |
| Material | Description | (mm) | (mm) | thickness | Compaction |
| A | Non-woven needled | 4.1 | 0.75 | 43% | 57% |
| | multi-layered carbon. | | | | |
| | Mixed fibre 10-150 mm, | | | | |
| | 211 gsm | | | | |
| B | Non-woven needled | 4.0 | 0.74 | 19% | 81% |
| | multi-layered carbon | | | | |
| | Mixed fibre 10-150 mm, | | | | |
| | 196 gsm | | | | |
| C | Non-woven needled | 6.0 | 1.15 | 19% | 81% |
| | multi-layered carbon. | | | | |
| | Chopped fibre 25 mm, | | | | |
| | 245 gsm | | | | |

Referring to FIG. 6, there is shown a graph schematically illustrating the behaviour of a fibrous layer of a plurality of non-woven carbon fibres which are substantially randomly oriented, the layer having loft, when compressed as compared to a fabric layer. Plot A shows the relationship between fibre volume fraction V_{f} and moulding pressure for a “lofty” fibrous layer of a plurality of non-woven carbon fibres which are substantially randomly oriented. Plot B shows the relationship between fibre volume fraction V_{f} and moulding pressure for a typical carbon fibre woven fabric.

It may be seen from Plot A that as the moulding pressure increases the fibre volume fraction V_{f} steadily increases to a value of about 15 to 20% at a pressure of about 10 to 20 bar and thereafter still increases, but at a lower rate, with increasing pressure to achieve a maximum fibre volume fraction V_{f} of about 40% to 50% at a pressure of from 50 to 100 bar. In other words, applying a compressive moulding pressure to a “lofty” compressible fibrous layer of a plurality of non-woven carbon fibres which are substantially randomly oriented can readily controllably vary the final fibre volume fraction V_{f} depending upon the selected applied compressive moulding pressure. The fibres are spread evenly through the thickness of the laminate.

In contrast, Plot B shows that for a typical carbon fibre woven fabric, as the moulding pressure increases the fibre volume fraction V_{f} rapidly increases to a maximum fibre volume fraction V_{f} of about 60% at a pressure of only about 1 to 5 bar, and thereafter remains constant with increasing pressure. The woven fabric has integrity and moulding at low volume fractions simply produces a laminate with the fabric floating in excess resin leaving large areas of non-reinforced resin through the thickness. In other words, with a typical woven carbon fibre fabric it is very difficult controllably to achieve a laminate with the fibres distributed evenly through the thickness at a desired fibre volume fraction V_{f} which is lower than the a volume fraction V_{f} of about 40 to 50%.

In the present invention, the ability to maintain the reinforcement substantially evenly distributed through the laminate thickness and control the fibre volume fraction V_{f} of a “lofty” compressible fibrous layer of a plurality of non-woven carbon fibres which are substantially randomly oriented is utilised in combination with relatively low compressive moulding pressures to provide different selected fibre volume fractions V_{f} in different regions of a moulded composite part.

The panel region can have relatively low fibre volume fraction V_{f}, to provide easy moulding of the visible cosmetic surface in combination with small panel thickness to reduce panel weight. Since the lower V_{f} is achieved by a lower compressive moulding pressure, the panel region is less compressed and therefore any inadvertently formed resin rich areas from a low areal weight of fibre in the small thickness panel region are not as significantly different to the neighbouring material and can readily be accommodated within the panel region without providing a visible discontinuity. In contrast, if the panel region is highly compressed during moulding, any inadvertently formed resin rich areas or high volume fraction areas from high local fibre weight area in the small thickness panel region would form visible witness marks at the surface of the panel. This would means that the surface would not qualify as an A-surface body panel for a vehicle.

In the reinforcement regions however, the reinforcement regions can have relatively high fibre volume fraction V_{f}, to provide a lower average density of the reinforcement regions and lower overall panel weight. The higher V_{f} is achieved by a higher compressive moulding pressure, and the reinforcement region is more compressed. Since the reinforcement regions have a greater number of plies than the panel region, and therefore a greater thickness, any inadvertently formed resin rich areas in the larger thickness reinforcement regions can readily be accommodated without causing reduced mechanical properties or visible witness marks.

The moulding cavity 66 comprises a first moulding region 96 for moulding the secondary structural region 46 and at least one second moulding region 98 for moulding the at least one primary structural region 10. The first moulding region 96 defines a first thickness ratio (T1) between the gap of the cavity 66 and a thickness of the panel part 62 of the preform. The second moulding region 98 defines a second thickness ratio (T2) between the gap of the cavity 66 and the assembly 60 of the panel part 62 and the reinforcement part 64 of the preform.

The first thickness ratio (T1) is higher than the second thickness ratio (T2). In some embodiments, the first thickness ratio is from 75% to less than 100% and the second thickness ratio is from 45% to less than 75%. In some preferred embodiments, the first thickness ratio is from 75% to 90% and the second thickness ratio is from 55% to 70%. Typically, the first thickness ratio is from 75% to 85% and the second thickness ratio is from 55% to 65%.

As a result of providing such differing thickness ratios, the degree of compression of the fibrous layers differs between on the one hand the panel part 62 of the preform and on the other hand the reinforcement part 64 of the preform, and consequently in the resultant secondary structural region 46 and at least one primary structural region 10.

In the press moulding step ii, in the first moulding region 94 each first random fibrous layer 88 is compressed by a first compression ratio (C1) and in the second moulding region 96 each first and second random fibrous layer 88, 94 is compressed by a second compression ratio (C2). The first compression ratio (C1) is lower than the second compression ratio (C2).

In some embodiments, the first compression ratio is from 5% to 25% and the second compression ratio is from greater than 25% to up to 50%. In preferred embodiments, the first compression ratio is from 10% to 25% and the second compression ratio is from 30% to 50%. Typically, the first compression ratio is from 15% to 25% and the second compression ratio is from greater than 35% to 45%.

By providing such different thickness and compression ratios between one hand the panel part 62 and on the other hand the reinforcement part 64, and consequently in the secondary structural region 46 and the resultant at least one primary structural region 10, in the compressive moulding step, in the first moulding region 96 the secondary structural region 46 is moulded at a compressive pressure of from 10 to 40 bar and in the second moulding region 98 the primary structural region 10 is moulded at a compressive pressure of from greater than 40 to up to 100 bar. In some embodiments, in the first moulding region 96 the secondary structural region 46 is moulded at a compressive pressure of from 20 to 40 bar and in the second moulding region 98 the primary structural region 10 is moulded at a compressive pressure of from 40 to 80 bar.

The mould tool 68 applies a higher compressive pressure to the one or more reinforced areas of the assembly 60 than to unreinforced areas of the panel part 62. The higher compressive pressure applied to the one or more reinforced areas of the assembly 60 than to unreinforced areas of the panel part 62 provides that in at least one primary structural region 10 both the panel portion 4 and the reinforcement portion 6 have a first volume fraction (V_{f1}) of fibres, with respect to the total volume of resin and fibres in that region, in the respective first and second plies 86, 92 within the respective primary structural region 10 which is higher than a second volume fraction (Vₜ₂) of fibres, with respect to the total volume of resin and fibres in that region, in at least one of the first plies 86 of the panel portion 4 in a secondary structural region 46 of the composite panel 2.

As described above, typically the first volume fraction (V_{f1}) is from greater than 30 vol % to up to 55 vol %, optionally from greater than 30 vol % to 45 vol %, further optionally from 35 vol % to 45 vol %, yet further optionally 45+/−5 vol % and/or the second volume fraction (Vₜ₂) is from 15 vol % to 30 vol %, optionally from 15 vol % to 25 vol %, further optionally from 20 vol % to 25 vol %, yet further optionally 25+/−5 vol %. In one example, the first volume fraction (V_{f1}) is from 35 to 45 vol % and the second volume fraction (V_{f2}) is from 20 to 35 vol %, with the proviso that the first volume fraction (V_{f1}) is higher than the second volume fraction (Vₜ₂).

If a surface film is present containing a filler, resin in the surface film may infuse into the fibrous layer, and, at the same time, at least a portion of the filler is filtered in the surface film to remain in the surface film. Thus, during the moulding step, at least a portion of thermosetting resin infuses into the fibrous material from the surface film, resulting in full or partial impregnation of the carbon fibres and concentrates the filler content remaining at the surface.

The fibrous layers may comprise needle holes. A needling process for random oriented carbon fibres players provides stabilisation but usually induces resin rich zones in cured parts made from alternative processes to this invention, and in particular resin rich zones can also form at the fibre cross overs on the part surface.

As described above, the used of differential compressive forces applied to the primary and secondary structural regions of the composite panel can avoid cosmetic and structural problems associated resin rich zones within the composite material.

The use of a surface film comprising filler can even further reduce any potential problems with needle holes. When such needle holes are present, the needle holes are at least partially filled with the filler material, originating from the surface film, during the moulding step. The filler can improve the surface quality since the filled needle holes would have a reduced tendency to read through into the final painted surface.

As the fibrous layer has high loft it absorbs a significant volume of the thermosetting resin during the moulding step. The fibrous layer acts as an effective filter to concentrate the filler particles within the thermosetting resin to form a high solids consistent resin layer between the fibrous layer and the A-Surface. By providing the embodiment of the present invention with a surface layer comprising a thermosetting resin and filler, it is possible to achieve an A-class finish at low areal weights.

The present invention is illustrated further with reference to the following non-limiting Example.

### EXAMPLE

An inner panel of an automobile hood was manufactured according to the present invention. The panel comprised a composite panel composed of a fibre reinforced resin matrix composite material. The inner panel was designed to function as stiffener to an outer hood exhibiting an A-surface front face.

A roll of prepreg material was provided. The prepreg material comprised a fibrous layer of a plurality of non-woven substantially randomly oriented carbon fibres impregnated with an epoxy resin. The fibrous layer has a carbon fibre areal weight of 200 grams per square metre. The areal weight of the roll had a tolerance of +/−20 wt %. Two first plies of the prepreg material were laid up on a sheeting table to form a multilayer laminate which was cut to form the required two-dimensional shape and dimensions. The multilayer laminate was provided between opposed outer layers of release film. Optionally the laminate may be clamped at its edges to prevent creasing of the prepreg layers. The multilayer laminate was then heated to soften the resin, and the heated laminate was then draped (in ambient temperature, i.e. at 20° C.) under the action of gravity and closing the mould tool at a closure rate of less than 10 mm per second after making contact with the upper mould onto a cold mould to form a preform. This preform was shaped to provide a preliminary shaping of the final inner panel. The cold mould caused the preform to be cooled which provided some rigidity to the moulded shape of the preform. The shaped preform may be subjected to an optional trimming process around its periphery, and may be heated or cooled prior to trimming.

Thereafter, the multilayer preform may be subjected to B-staging, by the application of heat and optionally pressure, to partly cure the resin and further rigidify the multilayer preform. Additionally or alternatively, the multilayer preform may be chilled prior to the subsequent steps.

Separately, a reinforcement part is assembled. The reinforcement part comprises a second multilayer laminate of the same prepreg material as used to form the panel part. Individual prepreg plies were cut using a prepreg cutter and assembled together to form a six ply multilaminar stack.

The reinforcement part was then assembled into position on a face of the panel part after removal of the release film from the uppermost face of the panel part. The reinforcement part comprised a number of local reinforcement patches which were located at the desired locations on the panel part. The reinforcement part provided primary structural areas of the assembly, and was composed of a stack of eight plies of the prepreg material, and secondary structural areas of the panel part, composed of a stack of two plies of the prepreg material, were not provided with the reinforcement part. The resultant preform assembly was then chilled and stored prior to press moulding, although the preform assembly may be press moulded directly.

In the press moulding step, the preform assembly of the panel part and the reinforcement part was located in a moulding cavity of a mould tool of a press mould. Then the preform assembly was press moulded in the mould tool to cause the resin to impregnate fibrous layers of the assembly and form a composite panel composed of a fibre reinforced resin matrix composite material.

The panel comprised a six ply reinforcement portion, formed from the reinforcement part, integrally moulded with a two ply panel portion, formed from the panel part, to provide eight ply primary structural regions of the composite panel. The two ply secondary structural areas of the panel part formed two ply secondary structural regions of the composite panel.

The two ply unreinforced panel portion had a thickness of 0.89+/−0.1 mm and the eight ply reinforced portion had a thickness of 3.33+/−0.1 mm With the 14.4% reinforcement area, arranged as 24 different reinforcement locations over the 1.68 m² hood inner panel, the panel weight was only about 2.4 kg. This weight was significantly lower than the weight of a conventional carbon fibre reinforced panel with constant fibre volume fraction in the panel part, having similar stiffness and dimensions.

During the press moulding the mould tool applied a higher compressive pressure to the eight ply primary structural areas of the assembly than to the two ply secondary structural areas of the panel part.

In the particular inner panel, the total surface area of the inner panel was 1.68 m². The surface area of the two ply secondary structural regions of the inner panel was 1.44 m² (85.6% of the total area) and the surface area of the eight ply primary structural regions of the inner panel was 0.24 m² (14.4% of the total area). The mould tool was in a press mould having a maximum pressing force of 5000 kNewtons. The distances between the moulding surfaces of the mould tool, in other words the height of the mould cavity between the two moulding surfaces, were configured, in combination with the thickness dimensions of the six ply reinforcement part and the two ply panel part, to apply different compressive pressures and forces to form the eight ply primary structural regions and the two ply secondary structural regions of the inner panel.

In particular, a pressure of approximately 20 bar was applied to the secondary structural areas, which required a force for the specific secondary structural areas subjected to 20 bar pressure of 2874 kiloNewtons, which provided a volume fraction in the primary structural regions of from 20 to 35%.

In contrast, a pressure of approximately 80 bar was applied to the primary structural areas, which required a force for the specific primary structural areas subjected to 80 bar pressure of 1927 kiloNewtons, which provided a volume fraction in the primary structural regions of from 35 to 45%.

The total force applied was 4801 kiloNewtons, within the capacity of the 5000 kiloNewtons press mould.

In a common moulding operation two different regions of the inner panel were provided with different fibre volume fractions using the same initial prepreg material. The press moulding could achieve a local moulding pressure of 80 bar, but with a press mould having a pressing force capacity of only 5000 kiloNewtons. Typically, in order to mould composite material parts of these dimensions, such as an automobile hood, art a moulding pressure of 80 bar, a press mould having a pressing force capacity of 25000 kiloNewtons would be employed, which typically costs approximately four times the cost of a press mould having a pressing force capacity of 5000 kiloNewtons. Accordingly, the present invention can employ a lower capacity and lower cost press mould to make composite components, such as automobile parts.

The press mould having a pressing force capacity of 5000 kiloNewtons would only be able to generate a moulding pressure of about 28 bar if the moulding pressure was evenly applied over the area of the moulding cavity. Also, such a moulding pressure would achieve a volume fraction V_{f} of only 22 to 34%. Accordingly, the present invention can employ a press mould to make composite components, such as automobile parts, in which the parts have reinforced areas with high volume fraction and areas without additional reinforcement which have low fibre volume fraction and therefore can have low weight.

The present invention can provide a number of technical advantages and effects over the prior art.

The preforming is a simple process. A single prepreg material can be employed. Some of the nesting waste from the drape forming can be used to make local reinforcements, known as pad up pieces, which can avoid the complication of using more than one fibrous or prepreg material.

Finite element analysis (FEA) of the inner panel for the automobile hood shows that using low volume fraction material in the majority of the part, namely the panel portion which is not additionally locally reinforced, does not unduly reduce the overall part stiffness provided that smaller area, high volume fraction, stiffer, thicker sections are made to provide the key mechanical properties of the inner panel so that a low overall panel weight can be achieved.

The lower fibre volume fraction areas are lower in density. If a minimal panel wall thickness is provided to prevent local crimping, avoid buckling and keep to a minimal tooling wall tolerance, the low volume fraction, low density panel areas are more weight efficient as a result of a reduction in density. The skilled person can readily determine, for any given panel design, a minimum panel wall thickness to achieve the desired mechanical properties as identified above.

The use of a low fibre volume fraction in the low structural areas, namely the panel portion which is not additionally locally reinforced, is cost efficient because the resin is generally lower in cost per unit weight than the non-woven carbon fibre material. The material costs of a panel with given mechanical properties can be reduced.

Using the combination in a composite panel of large area zones of low fibre volume fraction composite laminate and small area zones of high fibre volume fraction composite laminate allows parts to be made with less net moulding pressure. This allows lower cost press tools to be made and lower cost presses to be used.

In practice, commercially available non-woven fabrics comprised of substantially randomly oriented carbon fibres tend to exhibit an areal weight variation. A typical fabric tolerance for the areal weight over a fabric roll is up to, or even more than, +/−20%. When such a fabric is viewed with naked eye, small areas of locally much higher areal weight than the nominal overall areal weight are visible; the local high areal weight areas appear rather randomly like knots in wood.

When such areas of high areal weight are press moulded at high pressure to form thin laminates, there is a statistically high chance of the high areal weight areas resulting in visible witness marks in the moulded product, with potential associated variations in mechanical performance. The above effects get worse as the areal weight tolerance increases, because the statistical chance of aligning two or more high areal weight areas increases. The statistical chance of witness marks and mechanical performance also increases with increasing moulding pressure and decreasing wall thickness of the moulded part, and also increasing the target fibre volume fraction of the moulded part. In addition, such high areal weight areas increase the risk of preventing the proper closing of the mould tool, since the high areal weight areas have reduced compressibility compared to the bulk material. A typical mould tool tolerance is only 0.1 mm, and so any localised high areal weight areas preventing compression of the laminates by a thickness greater than the mould tolerance may prevent the mould from closing.

In the present invention, a majority of the surface area of the preform is press moulded to achieve a low fibre volume fraction, which reduces the risk of localised high fibre volume fraction areas in the thin tool sections and reduces the likelihood of a local alignment of any high areal weight areas, which otherwise could provide a first high areal weight area in one ply above a second high areal weight area in an adjacent ply, which could provide a local reduced compressibility which may be likely to prevent the mould tool from shutting.

In summary, in preferred embodiments of the present invention the final weight of a given carbon fibre panel can be reduced without compromising stiffness, and the panel can be produced reliably to achieve a high quality press moulded part on a low cost press using a layup composed of a single prepreg material.

Various other embodiments of the composite panel and manufacturing method of the present invention will be readily apparent to those skilled in the art.

1. A composite panel composed of a fibre reinforced resin matrix composite material, wherein the panel comprises:
a panel portion comprised of a first ply of fibre reinforced resin matrix composite material, wherein the first ply includes a first fibrous layer of a plurality of non-woven carbon fibres which are substantially randomly oriented, and
a reinforcement portion which is integrally moulded with the panel portion and is located at a location on a surface of the panel portion to provide an integrally moulded primary structural region of the composite panel, the reinforcement portion being comprised of at least one second ply of fibre reinforced resin matrix composite material, the second ply comprising a second fibrous layer,
wherein the first ply has a primary portion which is located in the primary structural region and a secondary portion which is adjacent to the primary portion and is located in a secondary structural region of the composite panel,
wherein in the primary portion the first ply has a first volume fraction (V_{f1}) of fibres in the first ply which is higher than a second volume fraction (V_{f2}) of fibres in the first ply in the secondary portion, each volume fraction being with respect to the total volume of resin and fibres in the respective portion.

2. The composite panel according to claim 1, wherein the first volume fraction (V_{f1}) is from greater than 30 vol % to up to 55 vol %, optionally from greater than 30 vol % to 45 vol %, further optionally from 35 vol % to 45 vol %, yet further optionally 45+/−5 vol %.

3. The composite panel according to claim 1, wherein the second volume fraction (V_{f2}) is from 15 vol % to 30 vol %, optionally from 15 vol % to 25 vol %, yet further optionally 25+/−5 vol %, or wherein the first volume fraction (V_{f1}) is from 35 to 45 vol % and the second volume fraction (V_{f2}) is from 20 to 35 vol %, with the proviso that the first volume fraction (V_{f1}) is higher than the second volume fraction (V_{f2}).

4. The composite panel according to claim 1, wherein the first ply or a laminate including the first ply defines at least a part of a front surface area of the panel and the at least one second ply is located at one or more locations on a rear surface of the panel and integrally moulded to a rear surface of the first ply or a laminate including the first ply.

5. The composite panel according to claim 4, wherein the first ply extends over from 50 to 100%, optionally from 90 to 100%, further optionally 100%, of the front surface of the panel and the at least one second ply extends over less than 50% of the rear surface of the panel.

6. The composite panel according to claim 1, wherein the first and second fibrous layers in the primary structural region have a thickness which is less than the thickness of the first fibrous layer in the secondary structural region.

7. The composite panel according to claim 1, wherein the primary structural region has a thickness of from 1.0 to 7.0 mm, optionally from 1.5 to 6.0 mm.

8. The composite panel according to claim 1, wherein the secondary structural region has a thickness of from 0.5 to 1.5 mm, optionally from 0.7 to 1.2 mm.

9. The composite panel according to claim 1, which comprises a plurality of the first plies, each of which includes a first fibrous layer, forming a first multilayer laminate.

10. The composite panel according to claim 1, wherein the second fibrous layer comprises a plurality of non-woven carbon fibres which are substantially randomly oriented.

11. The composite panel according to claim 1, which comprises a plurality of the second plies, each of which includes a second fibrous layer, forming a second multilayer laminate.

12. The composite panel according to claim 1, wherein the composite panel is a vehicle body panel.

13. A method of manufacturing a composite panel composed of a fibre reinforced resin matrix composite material, the method comprising the steps of:
i. locating in a moulding cavity of a mould tool of a press mould an assembly of a panel part and a reinforcement part which is disposed adjacent to the panel part and is located at one or more locations on a surface of the panel part to provide one or more primary structural areas of the assembly, there being at least one secondary structural area of the panel part adjacent to the primary structural area, the panel part being comprised of a first ply which includes a first fibrous layer of a plurality of non-woven carbon fibres which are substantially randomly oriented, and the reinforcement part being comprised of at least one second ply which includes a second fibrous layer, and the panel part and reinforcement part being provided with a resin; and
ii. press moulding the assembly in the mould tool to cause the resin to impregnate fibrous layers of the assembly and form a composite panel composed of a fibre reinforced resin matrix composite material in which a reinforcement portion, formed from the reinforcement part, is integrally moulded with the panel portion, formed from the panel part, to provide one or more primary structural regions of the composite panel, wherein the mould tool applies a higher compressive pressure to the one or more primary structural areas of the assembly than to the at least one secondary structural area of the panel part, the at least one secondary structural area of the panel part forming at least one secondary structural region of the composite panel.

14. The method according to claim 13, wherein in step ii the higher compressive pressure applied to the one or more primary structural areas of the assembly than to the at least one secondary structural area of the panel part provides that in at least one primary structural region both the panel portion and the reinforcement portion have a first volume fraction (V_{f1}) of fibres, with respect to the total volume of resin and fibres in the respective region, in the respective first and second plies within the respective primary structural region which is higher than a second volume fraction (V_{f2}) of fibres, with respect to the total volume of resin and fibres in the respective region, in at the first ply of the panel portion in the secondary structural region of the composite panel.

15. The method according to claim 14, wherein the first volume fraction (V_{f1}) is from greater than 30 vol % to up to 55 vol %, optionally from greater than 30 vol % to 45 vol %, further optionally from 35 vol % to 45 vol %, yet further optionally 45+/−5 vol %.

16. The method according to claim 14, wherein the second volume fraction (V_{f2}) is from 15 vol % to 30 vol %, optionally from 15 vol % to 25 vol %, yet further optionally 25+/−5 vol %, or wherein the first volume fraction (V_{f1}) is from 35 to 45 vol % and the second volume fraction (V_{f2}) is from 20 to 35 vol %, with the proviso that the first volume fraction (V_{f1}) is higher than the second volume fraction (V_{f2}).

17. The method according to claim 13, wherein in step ii a press mould applies a closure force to the mould tool, the closure force optionally being less than 10,000 kiloNewtons, further optionally less than 5,000 kiloNewtons.

18. The method according to claim 13, wherein in step ii a net pressure is applied to the mould tool, the net pressure being the force applied to the mould tool divided by the moulding area of the assembly being press moulded, the moulding area being projected onto a central plane of the mould tool which is orthogonal to the press moulding direction, the net pressure being within the range of from 2 to 50 bar, optionally from 2 to 30 bar, across the moulding area, optionally to generate localised compressive pressures of from 10 to 100 bar, optionally from 20 to 80 bar, within the moulding area.

19. The method according to claim 13, wherein the moulding cavity comprises a first moulding region for moulding the secondary structural region and at least one second moulding region for moulding the at least one primary structural region, the first moulding region defining a first thickness ratio between the gap of the cavity and a thickness of the panel part and the second moulding region defining a second thickness ratio between the gap of the cavity and the assembly of the panel part and the reinforcement part, wherein the first thickness ratio is higher than the second thickness ratio.

20. The method according to claim 19, wherein the first thickness ratio is from 75% to less than 100% and the second thickness ratio is from 45% to less than 75%, optionally wherein the first thickness ratio is from 75% to 90% and the second thickness ratio is from 55% to 70%, further optionally wherein the first thickness ratio is from 75% to 85% and the second thickness ratio is from 55% to 65%.

21. The method according to claim 19, wherein, in step ii, in the first moulding region the first fibrous layer is compressed by a first compression ratio and in the second moulding region each first and second fibrous layer is compressed by a second compression ratio, wherein the first compression ratio is lower than the second compression ratio.

22. The method according to claim 21, wherein the first compression ratio is from 5% to 25% and the second compression ratio is from greater than 25% to up to 50%, optionally wherein the first compression ratio is from 10% to 25% and the second compression ratio is from 30% to 50%, further optionally wherein the first compression ratio is from 15% to 25% and the second compression ratio is from greater than 35% to 45%.

23. The method according to claim 19, wherein, in step ii, in the first moulding region the secondary structural region is moulded at a compressive pressure of from 10 to less than 40 bar and in the second moulding region the primary structural region is moulded at a compressive pressure of from 40 to 100 bar, optionally in the first moulding region the secondary structural region is moulded at a compressive pressure of from 20 to less than 40 bar and in the second moulding region the primary structural region is moulded at a compressive pressure of from 40 to 80 bar.

24. The method according to claim 13, wherein each first and second fibrous layer has a loft such that when the fibrous layer is a subjected to a compressive load of 1 bar at 18-23° C. the thickness of the fibrous layer is reduced by at least 30%, optionally at least 45%.
